(19) United States
(12) Patent Application Publication
(10) Pub. No.: US 2006/0085423 A1
(43) Pub. Date: Apr. 20, 2006

(54) Rules of engagement for deterministic Web services

(75) Inventors: Eric L. Barsness, Pine Island, MN (US); Richard D. Dettinger, Rochester, MN (US); Scott N. Gerard, Rochester, MN (US); Daniel P. Kolz, Rochester, MN (US); Cale T. Rath, Byron, MN (US); Richard A. Saltness, Rochester, MN (US); John M. Santosuosso, Rochester, MN (US); Richard J. Stevens, Rochester, MN (US); Shannon E. Wenzel, Colby, WI (US)

Correspondence Address: William J. McGinnis;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/965,190

(22) Filed: Oct. 14, 2004

(51) Int. Cl. G06F 17/30

(52) U.S. Cl. 707/10

(57) ABSTRACT

Methods, articles of manufacture and systems for managing Web services. One embodiment provides a method comprising providing one or more rules configured to determine whether a Web service is deterministic. A deterministic Web service produces in subsequent executions identical output in response to identical input. The one or more rules are associated with the Web service.

### BACKGROUND OF THE INVENTION

1. Field of the Invention

The present invention generally relates to data processing and, more particularly, to managing Web services.

2. Description of the Related Art

The creation of increasingly powerful computer (or computing) systems and a continuously improved information technology (IT) infrastructure are accompanied by a widespread use of the Internet through the World Wide Web. The World Wide Web, hereinafter referred to as “WWW” or simply the “Web”, is particularly useful for the retrieval and exchange of information and for conducting businesses, such as electronic commerce. In the Web, linked pages of static content, composed of a variety of media, such as text, images, audio and video, are described using hypertext markup language (HTML).

As businesses began to conduct transactions via the Web, the development of Internet-based applications proliferated. Internet-based applications are configured to perform specific Internet-based services which are required to enable transactions via the Web. Typically, such applications are powered by Web application servers which dynamically generate HTML documents from server-side programming logic.

The popularity of conducting transactions over the Web has led to an increasing demand for businesses to integrate their Internet-based applications with Internet-based applications of other businesses. However, Internet-based applications are often implemented using proprietary software written in differing programming languages so that the integration of different Internet-based applications with each other can be a very inconvenient and tedious process. Therefore, instead of integrating different Internet-based applications with each other, the different underlying Internet-based services have been integrated.

One known solution for integrating heterogeneous Internet-based services is based on the concept of a “Web service”. Generally, a Web service is a collection of self-contained, self-describing, modular functions packaged as a single entity and published to a network for use by other programs. Web services are discoverable on a network and are capable of being remotely invoked from any Internet-based application regardless of the operating system and programming language in which they were developed. As a result, Web services facilitate the interoperability of Internet-based applications across platforms and geographical distances.

Web services are commonly described using the Web Services Description Language (WSDL). WSDL is an extensible Markup Language (XML)-based language used to describe the capabilities of a Web service (i.e. the operations it provides), where it resides, and how to invoke it. In WSDL, the operations and corresponding input/output messages are described in an abstract, platform-independent manner. These abstract descriptions are separately bound to concrete network protocols and data formats to facilitate actual use of the Web service.

Currently, Web services require a significant amount of processor and memory resources as well as bandwidth in the Internet due to the continuously increasing performance of transactions over the Internet. However, such resources are often wasted for Web services which frequently produce identical output in response to identical input. For instance, assume a given Web service which is invoked to access a database and to return a requested set of data. Assume further that the same Web service is subsequently re-executed against the database. If the database has been changed since the previous execution of the Web service, the requested set of data that will now be returned by the Web service may have changed in accordance with the changes to the database. However, as long as the database is unchanged, the Web service is deterministic, i.e., the Web service returns the same set of data in response to identical input. Accordingly, as long as the database is unchanged each subsequent execution of the deterministic Web service with the identical input can be considered as an undesirable waste of resources.

Therefore, there is a need for an efficient technique for identifying deterministic Web services.

### SUMMARY OF THE INVENTION

The present invention generally provides methods, articles of manufacture and systems for managing Web services and, more particularly, for identifying Web services which are deterministic or can be treated as being deterministic.

One embodiment provides a method for managing Web services. The method comprises providing one or more rules configured to determine whether a Web service is deterministic, whereby the Web service produces in subsequent executions identical output in response to identical input. The one or more rules are associated with the Web service.

Another embodiment provides a method for managing Web services comprising providing one or more rules configured to define conditions under which a Web service is treated as being deterministic, whereby the Web service produces in subsequent executions identical output in response to identical input. The one or more rules are associated with the Web service.

Another embodiment provides a computer readable medium containing a program which, when executed, performs a process for managing Web services. The process comprises receiving one or more rules configured to define conditions under which a Web service is treated as being deterministic, whereby the Web service produces in subsequent executions identical output in response to identical input. The one or more rules are associated with the Web service.

Still another embodiment provides a computer system, comprising a plurality of Web services residing in memory and a Web service manager residing in memory for managing the plurality of Web services. The Web service manager is configured for receiving one or more rules configured to define conditions under which a Web service is treated as being deterministic, whereby the Web service produces in subsequent executions identical output in response to identical input. The one or more rules are associated with the Web service.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a relational view of software components in one embodiment of the present invention.

FIG. 2 is a relational view of components implementing one aspect of the present invention.

FIG. 3 is a flow chart illustrating a method of creating Web services which are deterministic or can be treated as being deterministic in one embodiment.

FIG. 4 is a flow chart illustrating Web service execution management in one embodiment.

### DETAILED DESCRIPTION OF THE PREFERRED EMBODIMENTS

### Introduction

The present invention generally is directed to methods, articles of manufacture and systems for managing Web services and, more particularly, for identifying Web services which are deterministic or can be treated as being deterministic. A deterministic Web service is a Web service which always produces identical output in response to identical input in repeated executions of the Web service. Such a deterministic Web service may also be referred to hereinafter as a Web service having actual, or “inherent”, determinism. In contrast, a Web service with “imposed” determinism is a Web service which is not inherently deterministic, but which is treated as a deterministic Web service under certain conditions, regardless of whether the Web service actually operates deterministically under the certain conditions. Described in this way, the distinction between Web services that exhibit inherent determinism and imposed determinism highlights that the behavior of Web services having inherent determinism is always deterministic and, thus, perfectly predictable, while the behavior of Web services having imposed determinism is only predictable under certain conditions. In other words, Web services having imposed determinism are defined (assumed) to return identical output in response to identical input in repeated executions if the corresponding certain conditions are satisfied, even if these Web services would actually produce different output.

According to aspects of the invention, Web services having inherent determinism can be identified by analyzing the behavior of such Web services. Thus, deterministic attributes can be associated with these Web services to indicate the identified inherent determinism of the services. Web services which do not have an inherent determinism can be defined under certain conditions as having an imposed determinism. Likewise, Web services having imposed determinism may be associated with corresponding deterministic attributes which indicate the defined imposed determinism of the respective Web services. In this case, the deterministic attributes may describe the conditions under which these Web services can be treated as being deterministic. The deterministic attributes can then be used to improve Web service execution management.

More specifically, in one embodiment a Web service is created or retrieved from memory. The Web service is either inherently deterministic or not. The behavior of the Web service is then analyzed in order to determine whether the Web service is inherently deterministic. If the Web service is inherently deterministic, corresponding deterministic attributes can be associated with this Web service to indicate the inherent determinism. However, in most cases Web services are not inherently deterministic, as Web services are normally course-grained functions with complex interactions. Therefore, if the Web service is not inherently deterministic, determinism may be imposed on the Web service. In other words, certain conditions can be defined under which the Web service should be treated as being deterministic, regardless of whether the service actually operates deterministically under these conditions. Furthermore, it is also contemplated that determinism may be imposed on a given Web service upon creation of the given Web service without first determining whether the given Web service is inherently deterministic. For instance, a user who creates the given Web service may indicate the certain conditions under which the Web service should be treated as being deterministic. Then, the certain conditions are described by one or more rules which are then associated with the Web service. Accordingly, it can be determined upon receipt of a request for execution of the Web service whether the Web service can be treated as being deterministic, on the basis of the one or more rules.

### Data Processing Environment

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

Embodiments of the invention can be implemented in a hardware/software configuration including at least one networked client computer and at least one server computer. Furthermore, embodiments of the present invention can apply to any comparable hardware configuration, regardless of whether the computer systems are complicated, multi-user computing apparatus, single-user workstations, or network appliances that do not have non-volatile storage of their own. Further, it is understood that while reference may be made to Web services and WSDL, the invention is not limited to a particular implementation, standard or version. Instead, the invention is adaptable to any collection of self-contained, self-describing, modular functions packaged as a single entity that may be published to a network for use by other programs. Moreover, persons skilled in the art will recognize that the invention is adaptable to other languages which are suitable for describing Web services and that the invention is also adaptable to future changes in a particular language as well as to other languages presently unknown.

### Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

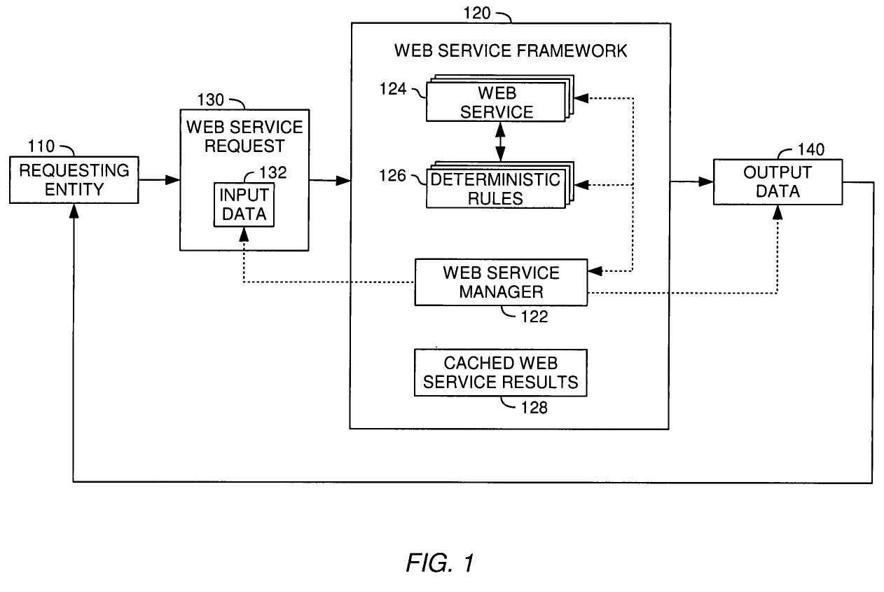

Referring now to FIG. 1, a relational view of software components in one embodiment is illustrated. According to one aspect, the software components are configured for managing Web services and Web service execution. Illustratively, the software components include a requesting entity 110 and a Web service framework 120.

In one embodiment, the requesting entity 110 issues Web service requests, such as Web service request 130, against the Web service framework 120. By way of example, the requesting entity 110 can be embodied by any application, an operating system or, at the highest level, users. The Web service requests issued by the requesting entity 110 may be predefined (i.e., hard coded as part of an application) or may be generated in response to input (e.g., user input). Each Web service request is a request for execution of a Web service provided by the Web service framework 120. By way of example, the Web service framework 120 includes all components which are required for processing the Web service request 130. It is contemplated that the Web service requests may specify specific Web services of the Web service framework 120. Alternatively, a given Web service request may be nonspecific and allow the Web service framework 120 to determine the appropriate Web service to handle the given Web service request.

Illustratively, the Web service request 130 is received by a Web service manager 122. The Web service manager 122 parses the Web service request 130 to determine input data 132. The input data 132 may be provided by the requesting entity 110 for a given requested Web service to be executed. In one embodiment, the Web service manager 122 retrieves the requested Web service from a plurality of Web services 124.

Prior to executing the requested Web service, the Web service manager 122 retrieves deterministic rules 126. On the basis of the deterministic rules 126, the Web service manager 122 determines for purposes of execution of the requested Web service whether the requested Web service is deterministic or can be treated as being deterministic under certain conditions. In one embodiment, if the Web service manager 122 determines that the requested Web service is deterministic, the Web service manager 122 retrieves a corresponding result for the requested Web service from cached Web service results 128 without executing the requested Web service. The Web service manager 122 then returns the corresponding retrieved result as output data 140 to the requesting entity 110. If, however, the requested Web service is not deterministic, i.e., not inherently deterministic, the Web service manager 122 identifies particular conditions from the deterministic rules 126 under which the requested Web service can be treated as being deterministic. In this case, the Web service manager 122 may retrieve a corresponding result for the requested Web service from the cached Web service results 128 if the particular conditions are satisfied. Thus, the corresponding result may be returned as the output data 140 to the requesting entity 110 without executing the requested Web service which can be treated as being deterministic.

Of course, in some cases a corresponding result may not have been previously cached so that the Web service manager 122 cannot access the result from the cached Web service results 128. In these cases, the requested Web service is executed to obtain the corresponding result, regardless of whether the Web service is inherently deterministic or treated as deterministic.

In each instance that a Web service is executed to obtain a result, the result may be cached in the Web service results 128 for future access. In one embodiment, the decision of whether or not to cache results is made by the Web service manager 122. More specifically, caching can be performed on the basis of predefined settings, which can be user- or application-specific. In other words, the Web service manager 122 can be configured to perform a selective caching or an unconditional continuous caching. For instance, the Web service manager 122 can be configured to (i) always cache results for Web services that are inherently deterministic, (ii) cache results of Web services that are treated as deterministic as long as corresponding particular conditions from the deterministic rules 126 under which the requested Web service can be treated as being deterministic are satisfied, and (iii) never cache results of other Web services. Furthermore, the Web service manager 122 can be configured to make the cached Web service results 128 retrievable based on user input values. As an example, assume a Web service that is configured to retrieve employee records from a database on the basis of a particular employee identifier (e.g., retrieveEmployeeRecord(String employee_ID)). Assume that this Web service is treated as deterministic as long as the database is not updated. Assume further that an employee record is initially retrieved for an employee having as unique identifier the employee_D ‘123-423-01’. The results of this Web service, i.e., the retrieved employee record, are captured and associated with a unique key which can be a composite of all input parameters. In the given example, the composite of all input parameters is the employee_ID ‘123-423-01’, which is the only input parameter. In one embodiment, the captured results and the unique key are cached in the cached Web service results 128. If a subsequent Web service request is received which requests an employee record for the same employee_ID and the particular conditions from the deterministic rules 126 under which the requested Web service can be treated as being deterministic are still satisfied, since the previous request, the cached employee record is returned. The cached employee record for the Web service request can be identified on the basis of the unique key, i.e., the employee_ID. Thus, execution of the Web service can be avoided.

However, it should be noted that many variations of the specific caching mechanism are envisioned. For example, Web service results that are able to be generated very quickly might never be configured to be cached. To this end, a duration of generation of a result for a given Web service can be measured and compared to a predefined threshold. If the duration exceeds the threshold, the result is not cached in the cached Web service results 128. Moreover, cache management and storage might also be done on a more granular scale than the entire Web service. For example, requests coming from individual client systems may be configured to cache separately (and use separate determinism rules). This would be readily recognized by those skilled in the art as being something that can be accomplished by increasing the amount of information stored in the caching key.

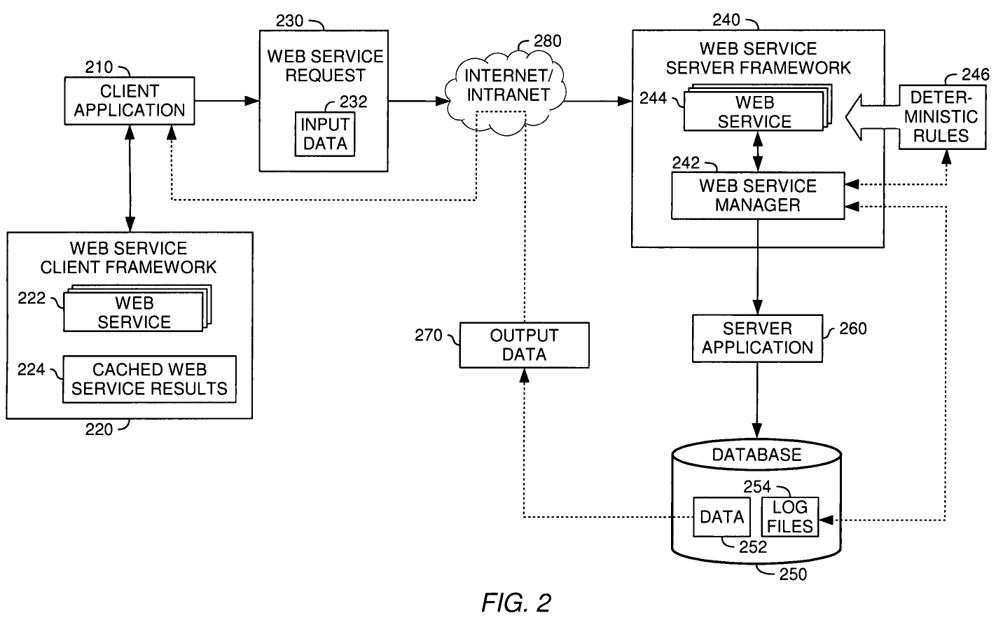

As was noted above, the Web service framework 120 illustratively includes all components which are required for processing the Web service request 130. However, it should be noted that these components can also be located separately at different locations in a given data processing environment. Furthermore, these components can be distributed over two or more computing systems which are connected via a network, such as the Internet. An exemplary relational view of software components implementing the invention in a distributed environment is described below with reference to FIG. 2.

Referring now to FIG. 2, a relational view of software components is shown. The software components are configured for managing execution of a requested Web service. Illustratively, the software components include a client application 210 (e.g., requesting entity 110 of FIG. 1), a Web service client framework 220, a Web service server framework 240 (e.g., Web service framework 120 of FIG. 1), and a server application 260.

The Web service server framework 240 provides a plurality of Web services 244 (e.g., Web services 124 of FIG. 1) which are accessible by local applications, such as the server application 260, or remote applications, such as the client application 210. The Web service client framework 220 may also include a plurality of Web services 222. The plurality of Web services 222 can likewise be accessed by local or remote applications, e.g., the client application 210 and the server application 260, respectively.

Illustratively, the client application 210 issues a Web service request 230 (e.g., Web service request 130 of FIG. 1) to the Web service server framework 240. The Web service request 230 is transmitted to the Web service server framework 240 over a network 280, such as an intranet or the Internet. By way of example, the Web service request 230 includes input data 232 (e.g., input data 132 of FIG. 1) and requests for execution of the requested Web service. Assume now that the requested Web service is configured for execution against a database 250. More specifically, assume that the requested Web service is configured to retrieve data from data 252 in the database 250 according to the input data 232 provided with the Web service request 230. The plurality of Web services 244 includes the requested Web service.

Illustratively, the Web service request 230 is received by a Web service manager 242 (e.g., Web service manager 122 of FIG. 1) of the Web service server framework 240. The Web service manager 242 determines for purposes of execution of the requested Web service whether the requested Web service is deterministic or can be treated as being deterministic under certain conditions. To this end, the Web service manager 242 retrieves and applies deterministic rules 246 (e.g., deterministic rules 126 of FIG. 1).

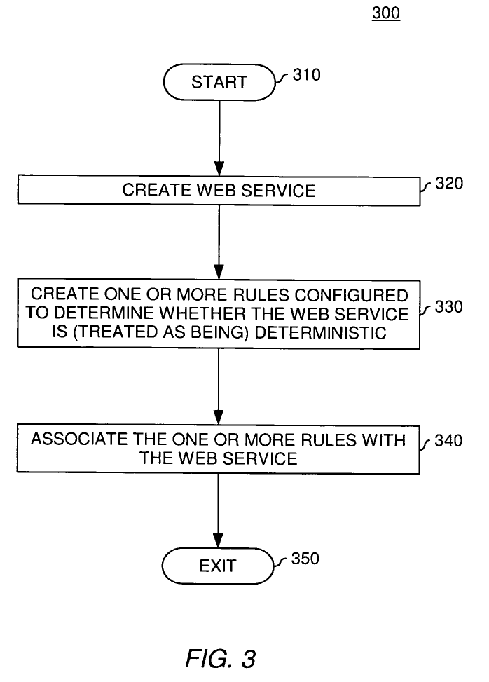

In one embodiment, the deterministic rules 246 are configured for determining whether the requested Web service is deterministic, i.e., inherently deterministic. For instance, the deterministic rules 246 may be defined to access and analyze metadata that includes deterministic attributes of the requested Web service, which indicate whether the requested Web service is deterministic. The deterministic rules 246 may further define that the requested Web service is deterministic if invoked by particular workflows or workflows having particular unique identifiers. These exemplary deterministic rules are explained in more detail below with reference to FIG. 3. In any case, the Web service manager 242 can determine on the basis of the deterministic rules 246 whether the requested Web service is deterministic, without performing an exhaustive analysis of the requested Web service at runtime.

Alternatively, the deterministic rules 246 can be configured to define conditions under which the requested Web service can be treated as being deterministic. As was noted above, this form of determinism is referred to herein as imposed determinism and may alternatively be referred to as contingent determinism, since whether the requested Web service will be treated as being deterministic is contingent on satisfaction of the defined conditions. By way of example only, and without limitation, these conditions may specify one or more of: (i) a predefined time frame, (ii) a particular requesting entity, (iii) a particular workflow, (iv) a workflow having a particular unique identifier, (v) an entity authentication associated with the client application 210, (vi) a domain authentication associated with the client application 210, (vii) a security certification authentication associated with the client application 210, and (viii) specific deterministic attributes/conditions defined in metadata, client and/or server policies. These exemplary conditions are also explained in more detail below with reference to FIG. 3. Thus, if the requested Web service is not inherently deterministic, the Web service manager 242 can determine on the basis of the deterministic rules 246 whether the requested Web service can be treated as being deterministic.

In one embodiment, the deterministic rules are provided as one or more external plug-ins on the server and/or client side for one or more Web services. Such plug-ins can be loaded to a corresponding Web service framework, such as Web service server framework 240 or Web service client framework 230, when required, i.e., at runtime. Thus, as the definition of determinism by means of the deterministic rules is performed by external plug-ins, no modifications are required to the corresponding Web service framework, i.e., the Web service client and/or server frameworks 230 and 240. In one embodiment, such plug-ins are created as eXtended Markup Language (XML) files implementing external declarations that can be loaded to the corresponding Web service framework. However, it should be noted that any other suitable implementation of the deterministic rules is broadly contemplated. With respect to a given Web service, the XML files may define one or more rules configured to determine when the Web service is deterministic, or one or more rules configured to indicate conditions under which the Web service can be treated as being deterministic. Specifically, with respect to imposed determinism the XML files can be specific to an application, user, group, system, and/or process, allowing a fine-grained definition thereof. For instance, plug-ins may be provided with rules which define particular conditions under which the given Web service can be treated as deterministic with respect to a user X, while no determinism is defined for user Y. Thus, as long as the particular conditions are satisfied, the behavior of the given Web service is predictable for user X, but not for user Y. In other words, user X will receive identical output for identical input in repeated executions of the given Web service as long as the particular conditions are satisfied. In contrast, user Y may receive different output for identical input even if the particular conditions are satisfied. Illustratively, the deterministic rules 246 are provided as a single plug-in which is provided on the server side, i.e., with the Web service server framework 240.

As was noted above, the requested Web service is configured to retrieve data from the database 250. Assume now that the deterministic rules 246 define conditions under which the requested Web service can be treated as being deterministic. Assume further that the conditions indicate that the requested Web service can only be treated as being deterministic as long as no changes occur to the data 252 of the database 250. Thus, the Web service manager 242 needs to determine whether the data 252 of the database 250 has been changed since a previous execution of the requested Web service. To this end, the Web service manager 242 may access database log files 254, which track all operations performed on the database 250.

In the given example, if the data 252 has been changed since the previous execution of the requested Web service, the requested Web service cannot be treated as being deterministic. In this case, the requested Web service is executed against the data 252 of the database 250 to obtain a corresponding Web service result. The Web service result is then returned as output data 270 to the client application 210. In the given example, the output data 270 is transmitted to the client application 210 over the network 280.

If, however, the data 252 or the database 250 has not been changed since the previous execution of the requested Web service, the requested Web service can be treated as being deterministic. Thus, the Web service result can be retrieved from cached Web service results 224, in one embodiment. Illustratively, the cached Web service results 224 are included with the Web service client framework 220 at the client side. Thus, the client application 210 must be notified that the Web service result can be retrieved from the cached Web service results 224. For instance, the input data 232 may include an indication that the Web service result can be retrieved from the cached Web service results 224 at the client side if the requested Web service can be treated as being deterministic. In this case, the output data 270 may include a notification to the client application 210 which indicates that the requested Web service can be treated as being deterministic. Thus, the client application 210 retrieves the Web service result from the cached Web service results 224 at the client side, whereby execution of the requested Web service can be omitted.

Referring now to FIG. 3, one embodiment of a method 300 for creating Web services which are deterministic, or can be treated as being deterministic, is illustrated. At least part of the steps of method 300 can be performed by a Web service manager (e.g., Web service manager 122 of FIG. 1 or 242 of FIG. 2). Method 300 starts at step 310.

At step 320, a given Web service (e.g., one of the plurality of Web services 124 of FIG. 1, or 222 or 244 of FIG. 2) is created. In one embodiment, the given Web service can be created as an inherently deterministic Web service or as a Web service to which determinism is subsequently imposed. Creating the given Web service includes creating a Web service specification describing one or more self-contained, self-describing, modular functions which are packaged as a single entity forming the Web service. For instance, the Web service specification can define one or more operations to be performed for retrieving data from a database (e.g., data 252 of database 250). Specifically, the Web service specification can be created using WSDL.

At step 330, one or more deterministic rules (e.g., deterministic rules 126 of FIG. 1 or 246 of FIG. 2) are created with respect to the created Web service. The deterministic rule(s) can subsequently be applied with respect to a corresponding request for execution of the created Web service (e.g., Web service request 130 of FIG. 1 or 230 of FIG. 2). Thus, it can be determined on the basis of the deterministic rule(s) whether the created Web service is deterministic or can be treated as being deterministic for purposes of execution of the created Web service.

In one embodiment, if the created Web service is inherently deterministic, the deterministic rule(s) may include an attribute(s) identifying the created Web service as being inherently deterministic. For example, the attribute of the deterministic rule may be a binary flag which, when set to a specified value (i.e., a binary one) indicates that the created Web service is inherently deterministic. If the created Web service is not inherently deterministic, it may be desirable to impose determinism on the Web service.

In the case of imposed determinism, the deterministic rule(s) can be used to define conditions under which the created Web service can be treated as being deterministic. By way of example, these conditions may specify a predefined time frame in which the created Web service can be treated as being deterministic. For instance, assume that the created Web service is configured for querying a database (e.g., database 250 of FIG. 2). Assume further that the created Web service behaves deterministically as long as the database does not change and that modifications to data of the database are only made at night, e.g., from 11:00 PM until 6:00 AM. In this case, the conditions may specify an imposed determinism for the created Web service in the time frame from 6:00 AM to 11:00 PM. The conditions may further specify an imposed determinism for the created Web service with respect to particular requesting entities or entities having particular unique identifiers. In other words, the conditions may specify that each request for execution of the created Web service with identical input, which is received from a particular requesting entity or an entity having a particular unique identifier, results in identical output (e.g., output data 140 of FIG. 1 or 270 of FIG. 2). Similarly, the conditions may specify that each request for execution of the created Web service with identical input, which is received from (i) a particular workflow, (ii) a workflow having a particular unique identifier, (iii) a requesting entity having a particular entity authentication, (iv) a requesting entity having a particular domain authentication, and (v) a requesting entity having a particular security certification authentication, results in identical output. In one embodiment, the conditions may be defined using metadata. As used herein, the term metadata refers to descriptive information including the attributes of Web services. For instance, by using metadata a Web service may make deterministic declarations about itself via the metadata which could be picked up at runtime by a Web service manager. Specifically, the Web service can be architected such that it could be asked if it is deterministic or if it can be treated as being deterministic given a series of conditions that had specifically not been executed. The conditions may further be defined using client and/or server policies, which can be stored at the client and/or server side, respectively. Furthermore, by providing policies which can be used by the Web service manager, deterministic behavior can be asserted. For example, a policy file can state that a given Web service can be treated as being deterministic to within 15 minutes, thereby allowing caching of Web service results for 15 minute time periods.

It should be noted that in the described examples of imposed determinism, actual repeated executions of the created Web service may not produce identical output in response to identical input, even if the predefined conditions are satisfied in the repeated executions. However, the imposed determinism defines that the identical output is returned in the repeated executions regardless of whether the created Web service actually behaves deterministically. For example, the identical output can be retrieved from cached Web service results (e.g., cached Web service results 128 of FIG. 1 or 224 of FIG. 2) without actual execution of the created Web service.

At step 340, the created deterministic rule(s) is associated with the created Web service. In one embodiment, associating the created deterministic rule(s) with the created Web service includes specifying a link to the deterministic rule(s) in the underlying Web service specification. For instance, if the Web service specification is provided in WSDL, a function call can be defined to invoke the deterministic rule(s) upon receipt of a request for execution of the created Web service. Alternatively, the Web service manager can be configured to check the deterministic rule(s) (which can be provided as plug-ins) automatically upon receipt of the request. Method 300 then exits at step 350.

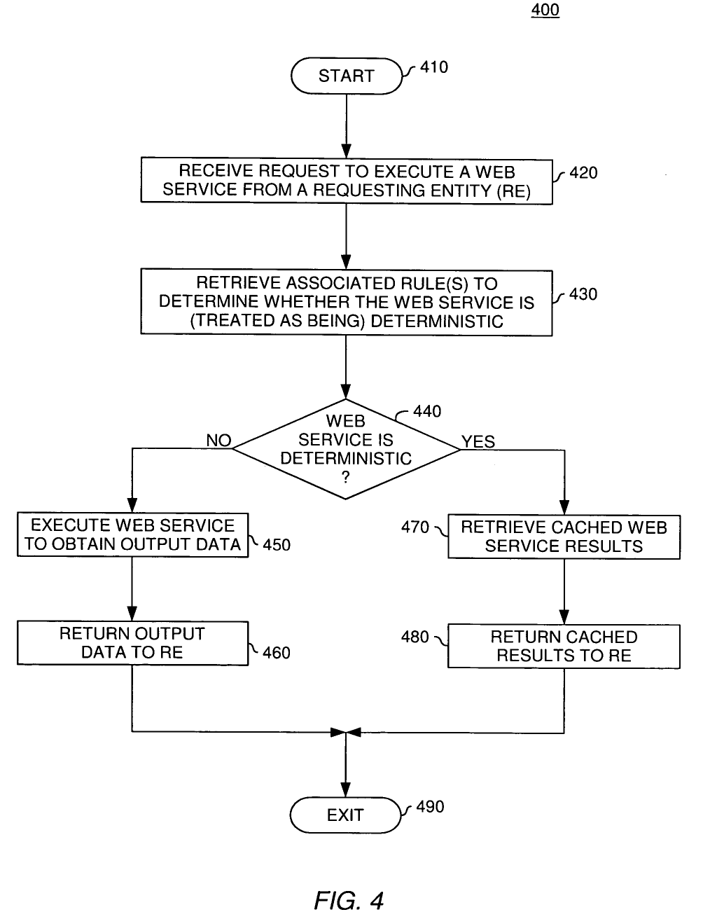

Referring now to FIG. 4, one embodiment of a method 400 for processing a Web service request is illustrated. At least part of the steps of method 400 can be performed by a Web service manager (e.g., Web service manager 122 of FIG. 1 or 242 of FIG. 2). Method 400 starts at step 410.

At step 420, a given Web service request (e.g., Web service request 130 of FIG. 1 or 230 of FIG. 2) is received from a requesting entity (e.g., requesting entity 110 of FIG. 1 or client application 210 of FIG. 2). At step 430, one or more deterministic rules (e.g., deterministic rules 126 of FIG. 1 or 246 of FIG. 2), which are associated with the given Web service, are retrieved. At step 440, it is determined on the basis of the retrieved deterministic rule(s) whether the given Web service is inherently deterministic or can be treated as being deterministic.

If the given Web service has no determinism at all, the service is executed at step 450 to obtain a Web service result (e.g., output data 140 of FIG. 1 or 270 of FIG. 2). The Web service result is then returned to the requesting entity at step 460. Method 400 then exits at step 490.

If, however, the given Web service is deterministic, the Web service result is retrieved in one embodiment from cached Web service results (e.g., cached Web service results 128 of FIG. 1 or 224 of FIG. 2). The retrieved Web service result is then returned to the requesting entity at step 480 and method 400 exits at step 490.

In various embodiments, the invention provides numerous advantages over the prior art. For instance, in one embodiment, either a developer of a Web service or an owner of the environment in which the Web service will be deployed can define how the Web service behaves for users. For instance, a Web service that accesses a database is generally not inherently deterministic as the database access is generally outside the control of the program runtime. In other words, as database changes are outside the control of the program runtime, the output of the Web service is not predictable and may vary if the database changes. However, according to aspects of the invention, determinism can be imposed to the Web service. Thus, the developer or owner may guarantee that all requesting entities will always receive identical output in response to identical input. Furthermore, the declaration of imposed determinism can be more or less fine-grained. For instance, a Web service accessing a database can be treated as being deterministic during working hours as data load might only happen during off-hours. Moreover, using transaction logs or triggers database changes can be monitored such that the Web service can be treated as being deterministic as long as the database remains unchanged. Thus, according to aspects of the invention, mechanisms are provided which are suitable to define Web services as behaving temporarily in a deterministic manner or to impose rules so that the Web services can be treated as being deterministic under certain predefined conditions.

While the foregoing is directed to embodiments of the present invention, other and further embodiments of the invention may be devised without departing from the basic scope thereof, and the scope thereof is determined by the claims that follow.

What is claimed is:

1. A method for managing Web services comprising:
providing one or more rules configured to define conditions under which a Web service is treated as being deterministic, whereby the Web service produces in subsequent executions identical output in response to identical input; and
associating the one or more rules with the Web service.

2. The method of claim 1, further comprising:
receiving a request for execution of the Web service in a predefined time frame; and
determining, on the basis of the one or more rules, whether the Web service is treated as being deterministic in the predefined time frame for purposes of performing the request.

3. The method of claim 1, further comprising:
receiving a request for execution of the Web service from a particular requesting entity; and
determining, on the basis of the one or more rules, whether the Web service is treated as being deterministic for purposes of performing the request for the particular requesting entity.

4. The method of claim 1, further comprising:
receiving a request for execution of the Web service in a predefined time frame from a particular requesting entity; and
determining, on the basis of the one or more rules, whether the Web service is treated as being deterministic for purposes of performing the request for the particular requesting entity in the predefined time frame.

5. The method of claim 1, further comprising:
receiving a request for execution of the Web service from a particular workflow; and
determining, on the basis of the one or more rules, whether the Web service is treated as being deterministic for purposes of performing the request for the particular workflow.

6. The method of claim 1, further comprising:
receiving a request for execution of the Web service from a particular workflow having a unique identifier; and
determining, on the basis of the one or more rules, whether the Web service is treated as being deterministic for purposes of performing the request for a group of workflows having identifiers including the unique identifier.

7. The method of claim 1, further comprising:
receiving a request for execution of the Web service from a particular requesting entity;
identifying an entity authentication of the requesting entity; and
determining, on the basis of the one or more rules, whether the Web service is treated as being deterministic for purposes of performing the request for a requesting entity having the identified entity authentication.

8. The method of claim 1, further comprising:
receiving a request for execution of the Web service from a particular requesting entity;
identifying a domain authentication associated with the requesting entity; and
determining, on the basis of the one or more rules, whether the Web service is treated as being deterministic for purposes of performing the request for a requesting entity associated with the identified domain authentication.

9. The method of claim 1, further comprising:
receiving a request for execution of the Web service from a particular requesting entity;
identifying a security certification authentication associated with the requesting entity; and
determining, on the basis of the one or more rules, whether the Web service is treated as being deterministic for purposes of performing the request for a requesting entity associated with the identified security certification authentication.

10. The method of claim 1, further comprising:
receiving a request for execution of the Web service;
parsing a Web service specification defining the Web service to identify metadata describing characteristics of the Web service from the Web service specification; and
applying the one or more rules to the identified metadata to determine whether the Web service is treated as being deterministic for purposes of performing the request.

11. The method of claim 1, further comprising:
receiving a request for execution of the Web service;
parsing at least one of a client and a server policy associated with the Web service to identify deterministic conditions for the Web service from the at least one of the client and server policy; and
applying the one or more rules to the deterministic conditions to determine whether the Web service is treated as being deterministic for purposes of performing the request.

12. The method of claim 11, wherein the Web service is configured to access a particular database and wherein the deterministic conditions indicate that the Web service is treated as being deterministic for purposes of performing the request if the database has not been changed since a previous execution of the Web service, the method further comprising:
determining a timestamp indicating a point of time of the previous execution; and
determining, from a transaction log of the database, whether transactions relative to the database have occurred since the point of time indicated by the timestamp.

13. The method of claim 1, further comprising:
receiving a request for execution of the Web service;
executing the Web service to obtain an initial output;
determining, on the basis of the one or more rules, whether the Web service is treated as being deterministic for purposes of performing the request; and
if so, caching the initial output in a manner allowing the cached output to be returned in response to subsequent requests for execution of the Web service without executing the Web service.

14. The method of claim 13, further comprising:
receiving a subsequent request for execution of the Web service;
determining, on the basis of the one or more rules, whether the Web service is treated as being deterministic for purposes of performing the subsequent request; and
if so, returning the cached output without executing the Web service.

15. The method of claim 1, wherein the Web service is configured to access a database, the method further comprising:
receiving a request for execution of the Web service;
determining whether the database has been changed since a previous execution of the Web service whereby the database was accessed; and
determining that the Web service is treated as being deterministic for purposes of performing the request if the database has not been changed since a previous execution of the Web service.

16. The method of claim 15, further comprising:
upon determining that the Web service is treated as being deterministic for purposes of performing the request, returning a predetermined result for the request, without executing the Web service.

17. A method for managing Web services comprising:
providing one or more rules configured to determine whether a Web service is deterministic, whereby the Web service produces in subsequent executions identical output in response to identical input; and
associating the one or more rules with the Web service.

18. The method of claim 17, further comprising:
receiving a request for execution of the Web service from a particular workflow; and
determining, on the basis of the one or more rules, whether the Web service is deterministic for purposes of performing the request for the particular workflow.

19. The method of claim 17, further comprising:
receiving a request for execution of the Web service from a particular workflow having a unique identifier; and
determining, on the basis of the one or more rules, whether the Web service is deterministic for purposes of performing the request for a group of workflows having identifiers including the unique identifier.

20. The method of claim 17, further comprising:
receiving a request for execution of the Web service;
parsing a Web service specification defining the Web service to identify metadata describing characteristics of the Web service from the Web service specification; and
applying the one or more rules to the identified metadata to determine whether the Web service is deterministic for purposes of performing the request.

21. A computer readable medium containing a program which, when executed, performs a process for managing Web services, the process comprising:
receiving one or more rules configured to define conditions under which a Web service is treated as being deterministic, whereby the Web service produces in subsequent executions identical output in response to identical input; and
associating the one or more rules with the Web service.

22. The computer readable medium of claim 21, wherein the process further comprises:
receiving a request for execution of the Web service in a predefined time frame; and
determining, on the basis of the one or more rules, whether the Web service is treated as being deterministic in the predefined time frame for purposes of performing the request.

23. The computer readable medium of claim 21, wherein the process further comprises:
receiving a request for execution of the Web service from a particular requesting entity; and
determining, on the basis of the one or more rules, whether the Web service is treated as being deterministic for purposes of performing the request for the particular requesting entity.

24. The computer readable medium of claim 21, wherein the process further comprises:
receiving a request for execution of the Web service in a predefined time frame from a particular requesting entity; and
determining, on the basis of the one or more rules, whether the Web service is treated as being deterministic for purposes of performing the request for the particular requesting entity in the predefined time frame.

25. The computer readable medium of claim 21, wherein the process further comprises:
receiving a request for execution of the Web service from a particular workflow; and
determining, on the basis of the one or more rules, whether the Web service is treated as being deterministic for purposes of performing the request for the particular workflow.

26. The computer readable medium of claim 21, wherein the process further comprises:
receiving a request for execution of the Web service from a particular workflow having a unique identifier; and
determining, on the basis of the one or more rules, whether the Web service is treated as being deterministic for purposes of performing the request for a group of workflows having identifiers including the unique identifier.

27. The computer readable medium of claim 21, wherein the process further comprises:
receiving a request for execution of the Web service from a particular requesting entity;
identifying an entity authentication of the requesting entity; and
determining, on the basis of the one or more rules, whether the Web service is treated as being deterministic for purposes of performing the request for a requesting entity having the identified entity authentication.

28. The computer readable medium of claim 21, wherein the process further comprises:
receiving a request for execution of the Web service from a particular requesting entity;
identifying a domain authentication associated with the requesting entity; and
determining, on the basis of the one or more rules, whether the Web service is treated as being deterministic for purposes of performing the request for a requesting entity associated with the identified domain authentication.

29. The computer readable medium of claim 21, wherein the process further comprises:
receiving a request for execution of the Web service from a particular requesting entity;
identifying a security certification authentication associated with the requesting entity; and
determining, on the basis of the one or more rules, whether the Web service is treated as being deterministic for purposes of performing the request for a requesting entity associated with the identified security certification authentication.

30. The computer readable medium of claim 21, wherein the process further comprises:
receiving a request for execution of the Web service;
parsing a Web service specification defining the Web service to identify metadata describing characteristics of the Web service from the Web service specification; and
applying the one or more rules to the identified metadata to determine whether the Web service is treated as being deterministic for purposes of performing the request.

31. The computer readable medium of claim 21, wherein the process further comprises:
receiving a request for execution of the Web service;
parsing at least one of a client and a server policy associated with the Web service to identify deterministic conditions for the Web service from the at least one of the client and server policy; and
applying the one or more rules to the deterministic conditions to determine whether the Web service is treated as being deterministic for purposes of performing the request.

32. The computer readable medium of claim 31, wherein the Web service is configured to access a particular database and wherein the deterministic conditions indicate that the Web service is treated as being deterministic for purposes of performing the request if the database has not been changed since a previous execution of the Web service, the process further comprising:
determining a timestamp indicating a point of time of the previous execution; and
determining, from a transaction log of the database, whether transactions relative to the database have occurred since the point of time indicated by the timestamp.

33. The computer readable medium of claim 21, wherein the process further comprises:
receiving a request for execution of the Web service;
executing the Web service to obtain an initial output;
determining, on the basis of the one or more rules, whether the Web service is treated as being deterministic for purposes of performing the request; and
if so, caching the initial output in a manner allowing the cached output to be returned in response to subsequent requests for execution of the Web service without executing the Web service.

34. The computer readable medium of claim 33, wherein the process further comprises:
receiving a subsequent request for execution of the Web service;
determining, on the basis of the one or more rules, whether the Web service is treated as being deterministic for purposes of performing the subsequent request; and
if so, returning the cached output without executing the Web service.

35. The computer readable medium of claim 21, wherein the Web service is configured to access a database, the process further comprising:
receiving a request for execution of the Web service;
determining whether the database has been changed since a previous execution of the Web service whereby the database was accessed; and
determining that the Web service is treated as being deterministic for purposes of performing the request if the database has not been changed since a previous execution of the Web service.

36. The computer readable medium of claim 35, wherein the process further comprises:
upon determining that the Web service is treated as being deterministic for purposes of performing the request, returning a predetermined result for the request, without executing the Web service.

37. A computer system, comprising:
a plurality of Web services residing in memory; and
a Web service manager residing in memory for managing the plurality of Web services, the Web service manager being configured for:
receiving one or more rules configured to define conditions under which a Web service is treated as being deterministic, whereby the Web service produces in subsequent executions identical output in response to identical input; and
associating the one or more rules with the Web service.
